(19) United States
(12) Patent Application Publication
(10) Pub. No.: US 2013/0141408 A1
(43) Pub. Date: Jun. 6, 2013

(54) Automatic Optical Detection Method and Optical Automatic Detector

(71) Applicant: Hao Kou, Shenzhen (CN)

(72) Inventor: Hao Kou, Shenzhen (CN)

(21) Appl. No.: 13/376,675

(22) PCT Filed: Dec. 6, 2011
(86) PCT No.: PCT/CN2011/083531

§ 371 Date: Dec. 7, 2011

(51) Int. Cl. G09G 5/00

(52) U.S. Cl. 345/207

(57) ABSTRACT

The present invention relates to an automatic optical detection method and an optical automatic detector. The automatic optical detection method includes the following steps: in the step of colored light projection, the lamplight with tricolor light is uniformly projected on an object to be detected to form images with different colors; gray-scale information corresponding to different zones of the images is obtained, then, an automatic optical inspection standard image is generated, and the automatic optical inspection standard image and a prestored reference image are contrastively detected. In the present invention, only the gray-scale information of the images needs processing, so the data quantity and the processing difficulty of an image processing unit and a statistical analysis unit are reduced, which is favorable for increasing the reliability, accuracy, repeatability and speed of data acquisition, and the present invention reduces the requirement of the detector, which is favorable for reducing the input cost of the detector.

### TECHNICAL FIELD

The present invention relates to an automatic optical detection method, in particular, an automatic optical detection method and an optical automatic detector which are used for a TFT-LCD (Thin Film Transistor Liquid Crystal Display).

### BACKGROUND ART

At present, all the automatic optical inspection systems in the TFT-LCD industry use a graphics contrast algorithm for detection, which means images are analyzed by the high-resolution photographic technique, the A/D conversion technique of images, the processing and analysis technique of data images, the computer automation control technique and the detection result statistics. However, these systems need to use expensive AOI equipment, so the cost is higher; because the image contrast technique is used, the amount of information generated during the A/D conversion of images is larger so as to generate larger negative effect on graphic processing.

### SUMMARY

For those reasons, it is necessary to provide an automatic optical detection method and an optical automatic detector with simplicity and lower cost.

An automatic optical detection method includes the following steps:

A: in the step of colored light projection, the lamplight with tricolor light is projected on an object to be detected, and the light forms images with different colors by spatial summation; gray-scale information corresponding to different zones of the images is obtained, and then, the automatic optical inspection standard image of the object is generated by the gray-scale information;

B: the automatic optical inspection standard image and a prestored reference image are contrastively detected.

Preferably, each kind of colored light has 256 gray-scale grades.

Preferably, in the step A, a light reflection method is used to obtain the gray-scale information corresponding to different zones of the images.

Preferably, in the step A, a light transmission method is used to obtain the gray-scale information corresponding to different zones of the images.

The automatic optical detection method of a liquid crystal substrate includes the following steps:

A: in the step of colored light projection, the lamplight with tricolor light is projected on a liquid crystal substrate to be detected, and the light forms images with different colors by spatial summation; gray-scale information corresponding to different zones of the images is obtained, and then, the automatic optical inspection standard image of the liquid crystal substrate is generated by the gray-scale information;

B: the automatic optical inspection standard image and a prestored reference image are contrastively detected.

Preferably, each kind of colored light has 256 gray-scale grades.

Preferably, in the step A, a light reflection method is used to obtain the gray-scale information corresponding to different zones of the images.

Preferably, in the step A, a light transmission method is used to obtain the gray-scale information corresponding to different zones of the images.

Preferably, the liquid crystal substrate comprises an array substrate and a color filter.

Preferably, the color filter has different zones, including the zones correspond to a black matrix, gap particles and a flat layer.

An optical automatic detector comprises a photographic device and an operation module, wherein the photographic device is used for obtaining the gray-scale information of the images of the object to be detected, and the operation module is connected with the photographic device by signals and is used for receiving the gray-scale information to generate an automatic optical detection standard image.

Preferably, the optical automatic detector comprises a tricolor projection device.

In the automatic optical detection method, the lamplight with tricolor light is uniformly projected on an object to be detected, so images with different colors are formed in different zones of the object to be detected by the spatial addition principle, and then, the gray-scale information of the images is obtained to generate an automatic optical inspection standard image. If a deficiency exists in the same zone, the gray-scale information in the place corresponding to deficiency can be abnormal, so the automatic optical inspection standard image and a prestored reference image are compared to find out the image zone with an abnormal gray scale, and then, the deficiency and the corresponding place can be found out. In the present invention, only the gray-scale information of the images needs processing, so the data quantity and the processing difficulty of an image processing unit and a statistical analysis unit are reduced, which is favorable for increasing the reliability, accuracy, repeatability and speed of data acquisition, and the present invention reduces the requirement of the detector, which is favorable for reducing the input cost of the detector.

### BRIEF DESCRIPTION OF FIGURES

FIG. 1 is a schematic diagram of the image formed by the light reflection method of the first preferred embodiment of the automatic optical detection method of the present invention.

FIG. 2 is a schematic diagram of the image formed by the light transmission method of the first preferred embodiment of the automatic optical detection method of the present invention.

FIG. 3 is a schematic diagram of tricolor spatial summation imaging of the automatic optical detection method of the present invention.

FIG. 4 is a schematic diagram of the tricolor light coordinate of the automatic optical detection method shown in FIG. 3.

### DETAILED DESCRIPTION

The present invention is further described by combining the Figures and the preferred embodiments.

The present invention relates to an optical automatic detector which comprises a photographic device and an operation module, wherein the photographic device is used for obtaining the gray-scale information of the image of an object to be detected, and the operation module is used for receiving the gray-scale information to generate an automatic optical detection standard image. The automatic optical detection method of the optical automatic detector can be used for detecting a liquid crystal substrate, a surface mounting technology, etc., and the automatic optical detection method used for detecting a liquid crystal substrate is described in the embodiment.

The manufacturing process of the TFT-LCD includes an array manufacturing process and a color filter manufacturing process. The graphics in the array manufacturing process and the color filter manufacturing process are formed with many layers, and each layer of graphics is different. Take the CF manufacturing process as an example, the graphics in different zones of CF are different; for example, the graphics of the black matrix, the gap particles and the flat layer are different in size and height.

The automatic optical detection method of the present invention used for detecting a color filter includes the following steps:

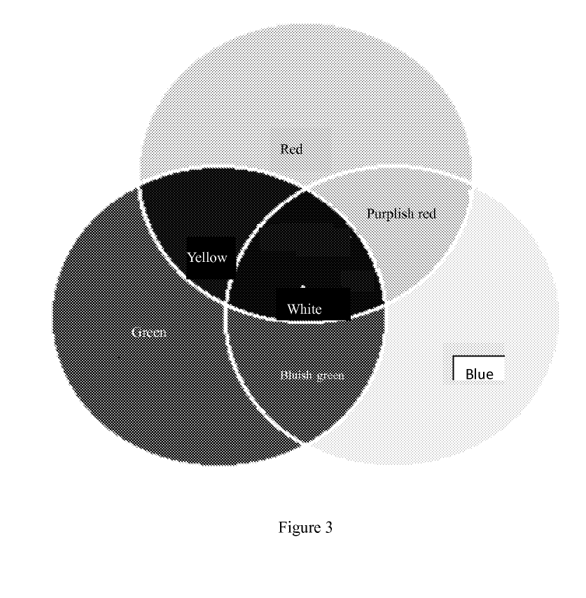

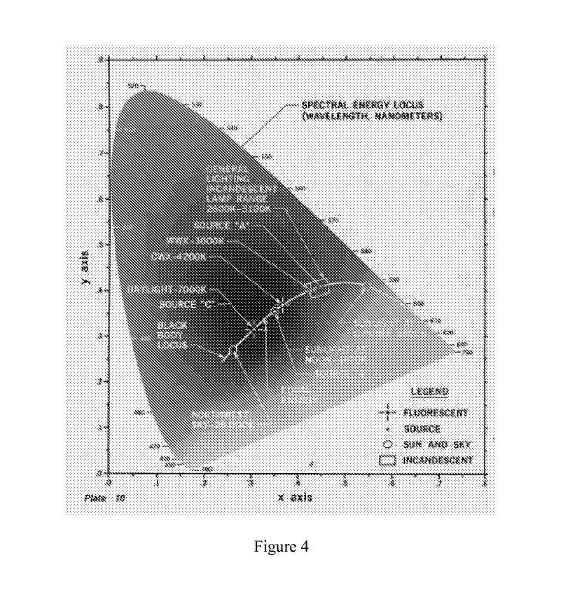

A1: In the step of colored light projection, tricolor light is projected on a color filter, by the spatial addition principle; spatial summation is carried out to the light to cause the images to become images with different colors, and a new color is formed at the place where light is mutually summed As shown in FIG. 3, the images processed by spatial summation have many colors, such as red, blue, green, yellow, white, purplish red, bluish green, etc., wherein yellow, white, purplish red and bluish green are formed by light summation.

Certainly, a series of middle colors can be obtained at the place where light is summed by changing the intensity of tricolor light, such as reddish orange, orange red, orange, orange yellow, yellowish orange, yellow, yellowish green, greenish yellow, etc. When green light and blue light are mixed, a series of middle colors between green and blue can be formed on the background. When blue light and red light are mixed, a series of middle colors between blue and red can be obtained. As long as the primary colors are proportionally mixed properly, red light and green light are mixed to obtain yellow light, and green light and blue light are mixed to obtain cyan.

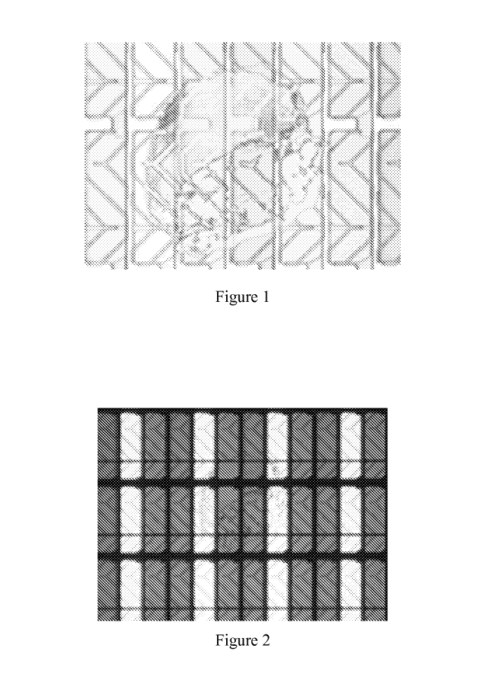

The colored light projection in this step can use a reflection method as well as a transmission method. The gray scale has 256 grades, which means the each kind of gray-scale information corresponds to a byte of data. The image effect of using the reflection method is shown in FIG. 1, and the image formed by the light reflection method has soft light quality and spreading brightness. The image effect formed by the transmission method is shown in FIG. 2, and the image formed by the light transmission method has rich, fine and soft layer transition and three-dimensional change.

A2: The gray-scale information corresponding to different zones of the images is obtained by a high-resolution video camera, and the automatic optical inspection standard image of the color filter is generated by the gray-scale information.

B: The automatic optical inspection standard image and a prestored reference image are contrastively detected.

Understandably, the automatic optical detection method can also be used in the SMT field to control and detect the quality of tin ointment printing, piece pasting machine pasting, reflow soldering, wave soldering, etc. For example, the automatic optical detection method can be used to detect the tin lack, redundant tin or deviation of tin ointment.

To sum up, because the lamplight with tricolor light(R/G/B) is uniformly projected on the formed image, and the spatial addition principle is used to obtain a standard image, the automatic optical detection method of the present invention reduces the use cost of AOI equipment and reduces the data quantity and the processing difficulty of an image processing unit and a statistical analysis unit, which is favorable for increasing the reliability, accuracy, repeatability and speed of data acquisition.

The above contents are only the preferred embodiments of the present invention, and do not limit the present invention in any form. Although the preferred embodiments of the present invention are disclosed above, the preferred embodiments are not used to limit the present invention. In the scope of the technical scheme of the present invention, the technical personnel acquainted with this field can revise or modify the technical contents to form an equivalent embodiment changed equivalently. Simple revision, equivalent change and modification in the scope of the contents of the technical scheme of the present invention, which are made to the embodiment on the basis of the technical substance of the present invention, belong to the protection scope of the technical scheme of the present invention.

1. An automatic optical detection method includes the following steps:
A: in the step of colored light projection, the lamplight with tricolor light is projected on an object to be detected, and the light forms images with different colors by spatial summation; gray-scale information corresponding to different zones of the images is obtained, and then, the automatic optical inspection standard image of the object is generated by the gray-scale information;
B: the automatic optical inspection standard image and a prestored reference image are contrastively detected.

2. The automatic optical detection method of claim 1, wherein each kind of colored light has 256 gray-scale grades.

3. The automatic optical detection method of claim 1, wherein in the step A, a light reflection method is used to obtain the gray-scale information corresponding to different zones of the images.

4. The automatic optical detection method of claim 1, wherein in the step A, a light transmission method is used to obtain the gray-scale information corresponding to different zones of the images.

5. The automatic optical detection method of a liquid crystal substrate includes the following steps:
A: in the step of colored light projection, the lamplight with tricolor light is projected on a liquid crystal substrate to be detected, and the light forms images with different colors by spatial summation; gray-scale information corresponding to different zones of the images is obtained, and then, the automatic optical inspection standard image of the liquid crystal substrate is generated by the gray-scale information;
B: the automatic optical inspection standard image and a prestored reference image are contrastively detected.

6. The automatic optical detection method of the liquid crystal substrate of claim 5, wherein each kind of colored light has 256 gray-scale grades.

7. The automatic optical detection method of the liquid crystal substrate of claim 5, wherein in the step A, a light reflection method is used to obtain the gray-scale information corresponding to different zones of the images.

8. The automatic optical detection method of the liquid crystal substrate of claim 5, wherein in the step A, a light transmission method is used to obtain the gray-scale information corresponding to different zones of the images.

9. The automatic optical detection method of a liquid crystal substrate of claim 5, wherein the liquid crystal substrate comprises an array substrate and a color filter.

10. The automatic optical detection method of a liquid crystal substrate of claim 9, wherein the color filter has different zones, including the zones correspond to a black matrix, gap particles and a flat layer.

11. An optical automatic detector, comprising: a photographic device and an operation module; the photographic device is used for obtaining the gray-scale information of the images of the object to be detected, and the operation module is connected with the photographic device by signals and is used for receiving the gray-scale information to generate an automatic optical detection standard image.

12. The optical automatic detector of claim 11, wherein the optical automatic detector comprises a tricolor projection device.
